(19) United States
(12) Patent Application Publication
(10) Pub. No.: US 2023/0328035 A1
(43) Pub. Date: Oct. 12, 2023

(54) METHOD AND FIREWALL CONFIGURED TO MONITOR MESSAGES TRANSITING BETWEEN TWO COMMUNICATION ELEMENTS

(71) Applicant: MBDA FRANCE, Le Plessis-Robinson (FR)

(72) Inventors: Sylvain Poinsard, Le-Plessis Robinson (FR); Cédrick Chevalier, Le-Plessis Robinson (FR); Romain Richer De Forges, Le-Plessis Robinson (FR)

(21) Appl. No.: 18/044,170

(22) PCT Filed: Aug. 19, 2021
(86) PCT No.: PCT/FR2021/051473

§ 371 Date: Mar. 6, 2023

(30) Foreign Application Priority Data
Sep. 14, 2020 (FR) 2009292

(51) Int. Cl. H04L 9/40

(52) U.S. Cl. CPC H04L 63/0245; H04L 63/0254; H04L 63/029; H04L 63/0263; H04L 63/123

(57) ABSTRACT

A firewall includes a verification unit for comparing messages transiting between the two communication elements with data, called reference data, contained in a database and for detecting, where applicable, a lack of conformity of a message in transit with respect to the reference data. The reference data includes predetermined messages and at least authorized values for fields of the predetermined messages. A central unit for generates an alert signal in the event of the verification unit detecting a lack of conformity of a message in transit. A transmission interface is configured to transmit any alert signal to at least one alert signal management device, which will generate an appropriate protective action when an alert signal is generated.

### TECHNICAL FIELD

The present invention relates to a method and a firewall configured to control messages transiting between two communication elements.

### PRIOR ART

In the scope of the present invention, it is meant:
communication element means any computer element such as a computer, a computer network, etc., which is capable of communicating with another computer element, by being capable of transmitting and/or receiving messages; and message means an assembly of data transmitted from one communication element to another.

Various application firewall solutions are known, such as firewall of WAF type (“Web Application Firewall”) or “pattern” recognition application firewalls.

In particular, firewalls are known for an OSI model (“Open System Interconnection”). These firewalls are generally very efficient on the layers 2 to 6 of the OSI model. However, for the applications (i.e. the layer 7 of the OSI model), the usual firewalls are limited to a functionality referred to as of “pattern” or of “signature”. The treatment is limited to looking at the content of the message only to find out whether a form of signature exists or not. They do not cover the security needs of the most critical applications in great depth.

These standard firewall solutions are therefore not satisfactory, in particular for the application layer of a communication model.

### DESCRIPTION OF THE INVENTION

The present invention relates to a firewall configured to control messages transiting in at least one direction between two communication elements, for example two computer networks or a computer and a computer network, which allows the aforementioned disadvantages to be remedied, said firewall comprising interfaces towards said communication elements.

To this end, according to the invention, said firewall further comprises:
a verification unit configured to compare messages transiting between the two communication elements with data referred to as reference data contained in at least one database and to detect, if necessary, a lack of conformity of a message in transit with respect to said reference data, said reference data comprising predetermined messages which are known and at least permitted values for fields of said predetermined messages. Advantageously, the permitted values for the fields of the messages comprise at least some of the following elements: ranges of values, minimum values, maximum values, types, sizes, etc.;
a central unit configured to generate an alert signal in case of detection by the verification unit of a lack of conformity of a message in transit; and
at least one transmission interface configured to transmit any alert signal that is generated to at least one alert signal management device.

Advantageously, said firewall is configured to control messages of an application layer of a communication model used for the communication between the two communication elements, in particular a layer referred to as “7” of an OSI model (for “Open System Interconnection”).

Thus, thanks to the invention, said firewall (of the application type) allows to verify, in real time, the conformity of the contents of the messages controlled with respect to predetermined reference data (concerning known messages). These reference data are adapted to the characteristics of the communication system in question and to the data and information intended to be exchanged by that communication system, as specified below.

The firewall thus verifies every message in transit for perfectly known and determined messages. The firewall is thus particularly well applied to the industrial domain, when the messages considered (received and/or emitted) are known.

In a preferred embodiment, said firewall is configured to control the messages transiting in both directions between the two communication elements.

Furthermore, advantageously, the verification unit is configured to recognise, among the messages transiting between the two communication elements, the same messages as those of the reference data, and the verification unit is configured to compare with the reference data only the messages which are thus recognised.

Furthermore, advantageously, the reference data contained in the database are transcribed into a computer format exploitable by the verification unit, preferably an XML format.

In a preferred embodiment, the reference data is representative of information intended to be exchanged between the communication elements. For example, for communication elements in an industrial unit, this may be information relating to products manufactured or used by that industrial unit or information for the operation or the management of that industrial unit.

The present invention also relates to a communication system comprising at least one communication element. According to the invention, said communication system further comprises at least one firewall as described above.

Advantageously, the communication system further comprises at least one database containing the reference data, said reference data thus comprising predetermined messages and at least permitted values for fields of said predetermined messages.

Advantageously, the communication system further comprises an alert signal management device configured to generate an action in case of reception of an alert signal from the firewall.

Advantageously, the alert signal management device is configured not to let a detected non-conforming message pass. In the context of the present invention, other actions are possible, as described below.

In a particular embodiment, the alert signal management device is configured to be able to generate a plurality of different possible actions and to generate, if applicable, from said plurality of possible actions, an action depending on the detected non-conforming message.

Furthermore, in a particular embodiment, the communication system also comprises at least one common auxiliary firewall.

The present invention further relates to a communication network which comprises at least said firewall and said two communication elements.

The present invention also relates to a method for treating and filtering messages transiting in at least one direction between two communication elements.

According to the invention, said method comprises at least:
a verification step, implemented by a verification unit, consisting in comparing messages transiting between the two communication elements with data referred to as reference data contained in a database, and in detecting, if necessary, a lack of conformity of a message in transit with respect to said reference data, said reference data comprising known predetermined messages and at least permitted values for fields of said predetermined messages; and
an alert step, implemented by a central unit, consisting in generating an alert signal in case of detection of a lack of conformity by the verification unit.

Advantageously, said method further comprises a protection step, implemented by an alert signal management device, consisting of implementing an action, in particular a protection action, in case of generation of an alert signal in the alert step.

In addition, advantageously, the verification step comprises:
an identification sub-step consisting in recognising, among the messages transiting between the two communication elements, the messages corresponding to the reference data; and
a comparison sub-step consisting of comparing only the messages that are so recognised with the reference data in said database.

### BRIEF DESCRIPTION OF FIGURES

The figures of the attached drawing will make it clear how the invention can be carried out. In these figures, identical references designate similar elements.

FIG. 1 is a block diagram of a communication network provided with a firewall conforming to the invention.

FIG. 2 shows schematically a particular embodiment of a firewall conforming to the invention.

FIG. 3 illustrates schematically the main steps of a message treating and filtering method, implemented using a firewall conforming with the invention.

### DETAILED DESCRIPTION

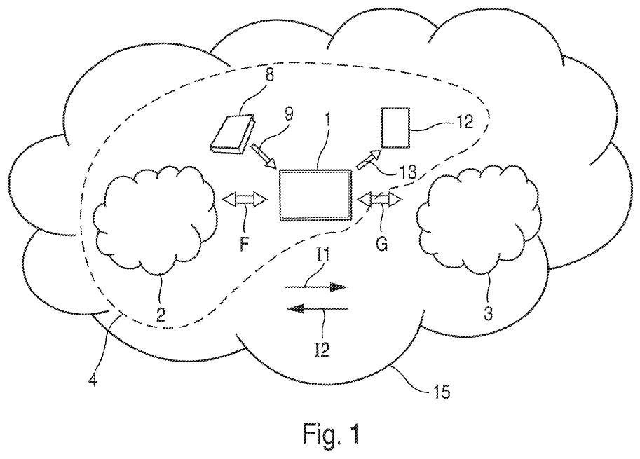

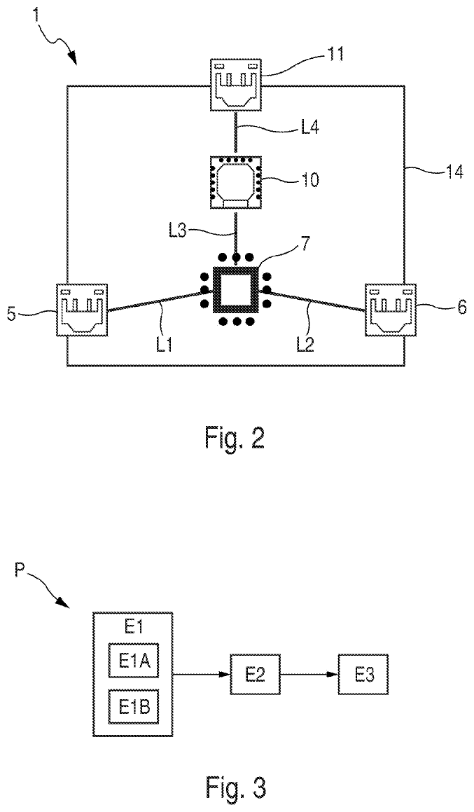

The firewall 1 shown schematically in FIG. 2 and allowing to illustrate the invention, is a computer device intended to control (or monitor) messages transiting, in at least one (communication) direction I1, I2, between two communication elements 2 and 3 shown in FIG. 1. In the context of the present invention, a communication element may correspond to any computer element (such as a computer, a computer network, e.g. a local area network (LAN), etc.) which is able to communicate with another computer element, i.e. which is able to transmit and/or receive messages from the latter.

The firewall 1 comprises interfaces 5 and 6 (shown in FIG. 2) allowing to connect it (in the usual way) to communication elements 2 and 3 respectively.

In a particular embodiment, said firewall 1 is configured to control the messages transiting in one direction I1 or I2 between the two communication elements 2 and 3. By way of illustration, these may be messages emitted from the communication element 3, for example a computer network external to an organisation or to a local entity such as a business, to the communication element 2, for example a computer or a network of the local entity, with the aim of protecting the communication element 2 against an non permitted message which could be potentially malicious and correspond, in particular, to an intrusion attempt.

In a preferred embodiment, shown in FIG. 1, said firewall 1 is thus a security element intended, in first instance, to protect the communication element 2, against malicious intrusion attempts from the communication element 3. For this purpose, it is part of a communication system 4 comprising, in particular, said communication element 2 and said firewall 1.

Furthermore, in a preferred variant of this preferred embodiment, said firewall 1 is configured to control the messages transiting in both directions I1 and I2 between the two communication elements 2 and 3, as illustrated by double arrows F and G in FIG. 1, to protect the two communication elements 2 and 3 from each other.

In a particular embodiment, the firewall 1 and the two communication elements 2 and 3 may be part of a communication network 15, for example a military (communication) network.

The firewall 1 comprises, as shown in FIG. 2, on an electronic board 14, in addition to the interfaces 5 and 6:
a verification (or control) unit 7, for example a Field-Programmable Gate Array (FGPA), which is configured (and programmed) to compare messages transiting between the two communication elements 2 and 3 with data referred to as reference data from a database 8. This reference data (concerning known messages) is received by the firewall 1 from the database 8, by means of a link 9, as shown in FIG. 1. By comparing each message (which is taken into account) with said reference data, the verification unit 7 is able to detect, if this is the case, any lack of conformity of a message in transit with respect to this reference data. In particular, the permitted values for the fields of the messages may comprise at least some of the following elements: value ranges, minimum values, maximum values, types, sizes, etc.;
a central unit 10, for example a processor or a treating central unit of the CPU type (Central Processing Unit), which is configured to generate an alert signal in case of detection by the verification unit 7 of a lack of conformity of a message in transit; and
at least one transmission interface 11 configured to transmit any alert signal generated by the central unit 10 to at least one user device, and in particular to an alert signal management device 12, as specified below.

The verification unit 7 is configured to be able to recognise (or identify), among the messages transiting between the two communication elements 2 and 3, the messages of the same type (e.g. of the same protocol) as those stored in the database 8. The verification unit 7 compares with the reference data of said database 8 only the contents of the messages (in transit between the two communication elements 2 and 3) which are thus previously recognised.

In addition to generating the alert signals, the central unit 10 is also configured to allow the management of the verification unit 7 and the downloading of the reference data from the database 8.

As shown in FIG. 2, the verification unit 7 is connected by means of links L1, L2 and L3 to the interface 5, the interface 6 and the central unit 10 respectively, and the central unit 10 is connected by means of a link L4 to the transmission interface 11. These links L1 to L4 allow the data communication between the elements connected together.

The interfaces 5 and 6 are responsible for transmitting and receiving messages that pass through the firewall 1, from or to the communication element 2 and the communication element 3 respectively.

The communication system 4 also comprises a database 8, preferably external to the electronic board 14, which contains the above-mentioned reference data. The reference data comprise at least:
a list of the assembly of the possible messages (which can therefore be treated by the firewall 1);
the assembly of the possible, i.e. permitted, values for each of the fields that make up each message.

In a particular embodiment, the firewall 1 may also comprise a number of databases 8, each of which, for example, comprises data relating to messages of a particular type in each case, which are, for example, intended for a particular project or a particular product. A database is any electronic means, such as a memory, which is part of the communication system 4 and which allow to store the assembly of the data necessary for allowing the verification unit 7 to carry out the intended comparisons.

Thus, said firewall 1 allows to verify, in real time, the conformity of the content of the controlled messages with respect to predetermined reference data. This reference data are adapted to the data exchanged by the communication system 4. The firewall 1 thus verifies each message in transit for perfectly known and determined messages.

In particular, the messages (controlled by the firewall 1) are fully known, and the possible content of each of these messages is precisely identified, for example, in interface documents used to define or update the reference data contained in the database 8. They may depend, in particular, on the data and information that it is envisaged that the communication system 4 will exchange. The documents specifying the interfaces and therefore the messages to be used for the communication system 4 allow a list of messages that can be used and the assembly of possible values for each field of these messages to be established in a precise manner. The firewall 1 is therefore particularly well suited to the industrial domain, and more specifically to the companies or the activity sectors in which the messages exchanged are perfectly known.

The firewall 1 can therefore read each message precisely and verify whether the values that make it up in the various fields are part of the possible values, and whether the message is therefore conforming or not.

For this purpose, the reference data in the database 8 is transcribed into a computer format exploitable by the verification unit 7 of the firewall 1, preferably an XML format.

The XML (Extensible Markup Language) files are simple text documents that use custom tags to describe and structure data. The XML message format used allows for the description of messages that are to be analysed at the application level. It contains the description of the different fields of each message (including in particular minimum values, maximum values, types, sizes) that are specified in the interface documents.

The present invention can be applied to different types of protocols, for example Transmission Control Protocol (TCP) or User Datagram Protocol (UDP).

The firewall 1 is of the application type. It is configured to control messages of an application layer of a communication model used for the communication between the two communication elements 2 and 3.

Preferably, the firewall 1 is configured to control messages of the layer 7 of the OSI model. The OSI model, which represents a network communication standard for computer systems, comprises seven layers. The layer 7, which is an application layer, is the access point to the network services. In the context of the present invention, the firewall 1 can also be applied to the application layer of a communication model other than the OSI model.

The communication system 4 furthermore comprises an alert signal management device 12, for example of the SIEM (Security Information and Event Management) type, which is configured to generate an action, in particular a protective action, in case of reception of an alert signal. For this purpose, the device 12 is connected by means of a link 13 (FIG. 1) to the transmission interface 11, which is connected to the central unit 10 (alert signal generator) via the link L4 (FIG. 2).

In a preferred embodiment, the alert signal management device 12 is configured to act, in the usual way, by not allowing a non-conforming message to pass. Thus:
a message received from the communication element 3, which is detected as non-conforming by the firewall 1, is not transmitted to the communication element 2 (and thus to the communication system 4) to protect it from a possible intrusion attempt;
and vice versa (in the preferred embodiment of a monitoring in both communication directions), a message emitted by the communication element 2 (and thus by the communication system 4), which is detected as non-conforming by the firewall 1, is not transmitted to the communication element 3.

In the context of the present invention, other actions (controlled or managed by the device 12) are conceivable in case of detection of a non-conforming message. By way of illustration, this may include deleting the message, archiving the message, transmitting the message to an analysis element (for analysing it), cutting off any further transmission between the communication elements 2 and 3, complex operations on the alert signals (such as time correlations for example), etc.

In a particular embodiment, the alert signal management device 12 is configured to generate an action which is dependent on the detected non-conforming message. A plurality of different possible actions is therefore provided for, and when a message is considered as non-conforming, at least one action (among said possible actions) which depends on said message is implemented. These actions may, for example, depend on the type of communication system 4, to which the firewall 1 is applied, or on the nature of the data exchanged by the communication system 4.

Furthermore, in a particular embodiment, the communication system 4 comprises, in addition to the firewall 1, one or preferably a plurality of usual auxiliary firewalls (not shown). This may include in particular one or more common firewalls that are designed to analyse messages that are not recognised by the verification unit 7 and are therefore not controlled by the firewall 1.

In particular, it may be one or more common firewalls that are designed to protect the layers 2 to 6 of the OSI models, and are thus complementary to the firewall 1 when it is intended to protect the layer 7 of the OSI model. In this particular embodiment, the communication system 4 thus has effective protections against the assembly of the layers 2 to 7 of the OSI model.

The firewall 1, as described above, being part of the communication system 4, allows to implement a method P for treating and filtering messages transiting in at least one (communication) direction between the two communication elements 2 and 3 or in both directions.

To this end, this method P comprises, as shown in FIG. 3:
a verification step E1, implemented by the verification unit 7, consisting of comparing messages transiting between the two communication elements 2 and 3 with the reference data in the database 8, and detecting, if necessary, a lack of conformity of a message in transit with respect to said reference data.

The reference data comprises predetermined messages that are known and permitted values for fields of said predetermined messages;
an alert step E2, implemented by the central unit 10, consisting in generating an alert signal in case of detection of a lack of conformity by the verification unit 7 in the verification step E1; and
a protection step E3, implemented by the alert signal management device 12, consisting in generating an action in case of generation of an alert signal by the central unit 10 in the alert step E2.

In addition, the verification step E1, implemented by the verification unit 7, comprises:
an identification sub-step E1A consisting of recognising and identifying, among the messages transiting between the two communication elements 2 and 3, the messages which are part of the reference data of the database 8; and
a comparison sub-step E1B consisting of comparing with said reference data of the database 8, only the messages which are thus recognised and identified.

Therefore, the verification unit 7 tries to recognise and identify all the messages in transit between the communication elements 2 and 3. A message that is not recognised by the verification unit 7 will not be controlled by the latter and will therefore be permitted to pass through the firewall 1. This message can be controlled by other common firewalls of the communication system 4, which will decide whether or not it conforms with the current security policy. It will then either be blocked by this usual firewall or allowed to pass.

On the other hand, a message that is recognised by the verification unit 7 will be controlled by the latter, which will emit an alert signal in case of lack of conformity of this controlled message with the corresponding reference data. In such a case, the alert signal management device 12 will generate an appropriate action. In particular, it will prevent the message from being communicated to the recipient communication element 2, 3.

The firewall 1 and the method P, as described above, can be used in many different applications. In particular, they are particularly well suited to the industrial domain (aviation, military, etc.), in companies or sectors of activity where the messages exchanged are perfectly known.

In the military domain, the firewall 1 can be in particular used in addition to the usual firewalls in order to provide an effective protection allowing for monitoring of the communication flows, in input and output of military systems such as a control centre, a mission preparation station, a launcher, etc.

1. A firewall configured to control messages transiting in at least one direction between two communication elements, said firewall comprising:
interfaces towards said communication elements;
a verification unit configured to compare messages transiting between the two communication elements with data and to detect, if necessary, a lack of conformity of a message in transit with respect to said data; and
a central unit configured to generate an alert signal in case of detection by the verification unit of a lack of conformity of a message in transit, wherein:
the verification unit is configured to compare the messages transiting between the two communication elements with reference data which are contained in at least one database and to detect, if necessary, a lack of conformity of a message in transit with respect to said reference data, said reference data comprise predetermined messages which are known and at least permitted values for fields of said predetermined messages;
the verification unit is configured to recognise, among the messages transiting between the two communication elements, the same messages as the messages of the reference data, and to compare with the reference data only the messages which are recognised; and
the firewall further comprises at least one transmission interface configured to transmit any alert signal to at least one alert signal management device.

2. The firewall of claim 1, wherein the firewall is configured to control messages of an application layer of a communication model used for the communication between the two communication elements.

3. The firewall of claim 1, it wherein the firewall is configured to control the messages transiting in both directions between the two communication elements.

4. The firewall according to claim 1, wherein the reference data is transcribed into a computer format exploitable by the verification unit.

5. The firewall according to claim 1, wherein the reference data is representative of the information to be exchanged between the communication elements.

6. A communication system comprising at least one communication element, comprising at least one firewall according to claim 1.

7. The communication system of claim 6, comprising at least one database containing reference data, said reference data comprising predetermined messages and at least permitted values for fields of said predetermined messages.

8. The communication system of claim 6, further comprising an alert signal management device configured to generate an action in case of reception of an alert signal from the firewall.

9. The communication system of claim 8, wherein the alert signal management device is configured prevent a detected non-conforming message from passing.

10. The communication system of claim 8, wherein the alert signal management device is configured to generate an action depending on the detected non-conforming message.

11. The communication system of claim 6, comprising at least one auxiliary firewall.

12. A method for treating and filtering messages transiting in at least one direction between two communication elements, said method comprising at least:
a verification step, implemented by a verification unit, consisting in comparing messages transiting between the two communication elements with data reference data contained in a database, and in detecting, if necessary, a lack of conformity of a message in transit with respect to said reference data, said reference data of the database comprising predetermined messages which are known and at least permitted values for fields of said predetermined messages, the verification step comprising an identification sub-step consisting in recognising, among the assembly of the messages transiting between the two communication elements, the messages corresponding to the reference data, and a comparison sub-step consisting in comparing with the reference data of said database, only the messages which are recognised; and
an alert step, implemented by a central unit, consisting in generating an alert signal in case of detection of a lack of conformity by the verification unit.

13. The method according to claim 12, further comprising a protection step, implemented by an alert signal management device, consisting of implementing an action in case of generation of an alert signal in the alert step.
